(19) United States
(12) Patent Application Publication
(10) Pub. No.: US 2013/0231805 A1
(43) Pub. Date: Sep. 5, 2013

(54) SWIMMING HOOP RINGS FOR DETECTING SAFETY OF CHILDREN

(71) Applicant: YAT WAI EDWIN KWONG, Hong Kong (HK)

(72) Inventor: YAT WAI EDWIN KWONG, Hong Kong (HK)

(21) Appl. No.: 13/410,469

(22) Filed: Mar. 2, 2012

(51) Int. Cl. B63H 25/42; G08B 21/08

(52) U.S. Cl. CPC B63H 25/42; G08B 21/088
USPC 701/21

(57) ABSTRACT

A swimming hoop ring is provided for detecting safety of children. In one embodiment, a swimming hoop ring includes a ring made of plastic, wherein the ring is being worn by a child; a top GPS receiver on a top surface of the ring, wherein the top GPS receiver is used to detect location of the ring when the top surface of the ring surfaces onto water; a bottom GPS receiver on a bottom surface of the ring, wherein the bottom GPS server can be used to detect location of the ring when the top GPS receiver fails to operate as the top surface of the ring is flipped upside down into the water; a rf transmitter included in the ring, wherein the rf transmitter can be used to transmit rescue signals; a propeller included in the ring to steer the ring in certain directions; and a weight detector included in the ring to detect if there is a sudden drop of weight of the ring to indicate the child is being unsafe.

### FIELD OF THE INVENTION

This invention generally relates to swimming equipment. Specifically, but not related to, this invention relates to swimming hoop rings that can ensure children safety.

### BACKGROUND OF THE INVENTION

There are lots of advantages to swim in a swimming pool. Comparing to swimming in the sea, swimming in the swimming pool can equally be enjoyable. More importantly, swimming in the pool is much safer. For parents, letting their children swim in the swimming pool makes parents feel safe because there are safeguards in the swimming pool to safeguard the children, to make sure that the children can get help when needed. Not everyone, however, like to swim in the swimming pool. Some may feel that there is too much chlorine in the pool and others just simply feel that it is too crowded to swim in the pool. Some would go to swim in the sea. However, these people need to make sure of the sufficient safety features are provided to the children. Children swimming in the sea can be dangerous for several reasons. One, water depth is unpredictable. In a pool, the water depth is clearly indicated. In the sea, all of a sudden the water depth may go down by a wide margin, and as such it can be dangerous to any swimmers, particularly children. Also, in a pool, there is no dangerous sea animals that can cause harm. In the sea, there are different kinds of sea animals that can be life threatening to human beings. The most well-known species of such kinds includes sharks, which are active in certain sea areas. Currently, there is no practical means to avoid such dangerous. Therefore, there is a need that allows swimmers to swim safely.

### SUMMARY OF THE INVENTION

According to embodiments of the present invention, a swimming hoop ring for detecting safety of children is provided. The swimming hoop ring comprises a ring made of plastic. The ring may be worn by a child. A top GPS receiver may be included on a top surface of the ring. The top GPS receiver may be used to detect location of the ring when the top surface of the ring surfaces onto water; a bottom GPS receiver on a bottom surface of the ring. The bottom GPS server can be used to detect location of the ring when the top GPS receiver fails to operate as the top surface of the ring is flipped upside down into the water; a rf transmitter included in the ring, wherein the rf transmitter can be used to transmit rescue signals; a propeller included in the ring to steer the ring in certain directions; a weight detector included in the ring to detect if there is a sudden drop of weight of the ring to indicate the child is being unsafe.

The swimming hoop provides a method comprising detecting whether the child is currently safe, wherein the detection includes: using the top GPS receiver or the bottom GPS receiver to detect the current location of the ring; and if water depth of the current location exceed a certain limit, indicating that the child is currently unsafe; and if the child is currently unsafe, directing the ring to a safe location, wherein the directing comprises: using the propeller included in the ring to steer the ring in a direction with a water depth that is lower than the certain limit. Alternatively, the swimming hoop ring provides another method comprising detecting whether the child is currently safe, wherein the detection includes: using the top GPS receiver or the bottom GPS receiver to detect the current location of the ring; if water depth of the current location exceed a certain limit, indicating that the child is currently unsafe; and if the current location belongs to an active area with dangerous water animals, indicating that this the child is currently unsafe; and if the child is currently unsafe, directing the ring to a safe location, wherein the directing comprises: using the propeller included in the ring to steer the ring in a direction with a water depth that is lower than the certain limit; and using the rf transmitter to transmit rescue signals.

In another embodiment, the exemplified method comprises detecting whether the child is currently safe, wherein the detection includes: using the top GPS receiver or the bottom GPS receiver to detect the current location of the ring; if water depth of the current location exceed a certain limit, indicating that the child is currently unsafe; if the current location belongs to an active area with dangerous water animals, indicating that this the child is currently unsafe; if the ring is detached from the child, as detected by a sudden drop of weight of the ring, detected by the weight detector; and if the child is currently unsafe, directing the ring to a safe location, wherein the directing comprises: using the propeller included in the ring to steer the ring in a direction with a water depth that is lower than the certain limit; and using the rf transmitter to transmit rescue signals.

### BRIEF DESCRIPTION OF THE DRAWINGS

FIG. 1 illustrates a swimming hoop ring system, according to an embodiment of the present invention.

### DETAILED DESCRIPTION

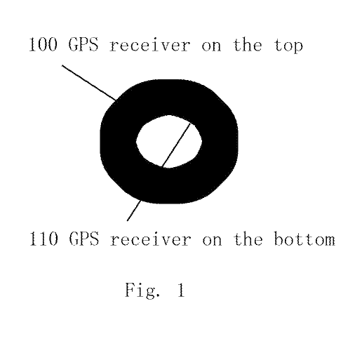

In the present invention, a swimming hoop ring is disclosed. For detecting safety of children, a swimming hoop ring provided. Referring to FIG. 1, the ring comprises a ring made of plastic, wherein the ring is being worn by a child; a top GPS receiver on a top surface of the ring, wherein the top GPS receiver is used to detect location of the ring when the top surface of the ring surfaces onto water; a bottom GPS receiver on a bottom surface of the ring, wherein the bottom GPS server can be used to detect location of the ring when the top GPS receiver fails to operate as the top surface of the ring is flipped upside down into the water; a rf transmitter included in the ring, wherein the rf transmitter can be used to transmit rescue signals; a propeller included in the ring to steer the ring in certain directions; a weight detector included in the ring to detect if there is a sudden drop of weight of the ring to indicate the child is being unsafe; a processor; a memory storing instructions that can execute the processor to execute a method, the method comprising: detecting whether the child is currently safe; and if the child is currently unsafe, directing the ring to a safe location. In another example, a swimming hoop ring for detecting safety of children is provided. The ring comprises: a ring made of plastic, wherein the ring is being worn by a child; a top GPS receiver on a top surface of the ring, wherein the top GPS receiver is used to detect location of the ring when the top surface of the ring surfaces onto water; a bottom GPS receiver on a bottom surface of the ring, wherein the bottom GPS server can be used to detect location of the ring when the top GPS receiver fails to operate as the top surface of the ring is flipped upside down into the water; a rf transmitter included in the ring, wherein the rf transmitter can be used to transmit rescue signals; a propeller included in the ring to steer the ring in certain directions; a weight detector included in the ring to detect if there is a sudden drop of weight of the ring to indicate the child is being unsafe; a processor; a memory storing instructions that can execute the processor to execute a method, the method comprising: detecting whether the child is currently safe, wherein the detection includes: using the top GPS receiver or the bottom GPS receiver to detect the current location of the ring; and if water depth of the current location exceed a certain limit, indicating that the child is currently unsafe; and if the child is currently unsafe, directing the ring to a safe location, wherein the directing comprises: using the propeller included in the ring to steer the ring in a direction with a water depth that is lower than the certain limit. Another example is provided with a swimming hoop ring for detecting safety of children, comprising: a ring made of plastic, wherein the ring is being worn by a child; a top GPS receiver on a top surface of the ring, wherein the top GPS receiver is used to detect location of the ring when the top surface of the ring surfaces onto water; a bottom GPS receiver on a bottom surface of the ring, wherein the bottom GPS server can be used to detect location of the ring when the top GPS receiver fails to operate as the top surface of the ring is flipped upside down into the water; a rf transmitter included in the ring, wherein the rf transmitter can be used to transmit rescue signals; a propeller included in the ring to steer the ring in certain directions; a weight detector included in the ring to detect if there is a sudden drop of weight of the ring to indicate the child is being unsafe; a processor; a memory storing instructions that can execute the processor to execute a method, the method comprising: detecting whether the child is currently safe, wherein the detection includes: using the top GPS receiver or the bottom GPS receiver to detect the current location of the ring; if water depth of the current location exceed a certain limit, indicating that the child is currently unsafe; and if the current location belongs to an active area with dangerous water animals, indicating that this the child is currently unsafe; and if the child is currently unsafe, directing the ring to a safe location, wherein the directing comprises: using the propeller included in the ring to steer the ring in a direction with a water depth that is lower than the certain limit; and using the rf transmitter to transmit rescue signals.

Alternatively, the swimming hoop ring can be worn by a child; a top GPS receiver on a top surface of the ring, wherein the top GPS receiver is used to detect location of the ring when the top surface of the ring surfaces onto water; a bottom GPS receiver on a bottom surface of the ring, wherein the bottom GPS server can be used to detect location of the ring when the top GPS receiver fails to operate as the top surface of the ring is flipped upside down into the water; a rf transmitter included in the ring, wherein the rf transmitter can be used to transmit rescue signals; a propeller included in the ring to steer the ring in certain directions; a weight detector included in the ring to detect if there is a sudden drop of weight of the ring to indicate the child is being unsafe; a processor; a memory storing instructions that can execute the processor to execute a method, the method comprising: detecting whether the child is currently safe, wherein the detection includes using the top GPS receiver or the bottom GPS receiver to detect the current location of the ring.

If water depth of the current location exceeds a certain limit, indication can be made to parents that the child is currently unsafe; if the current location belongs to an active area with dangerous water animals, indicating that this the child is currently unsafe; if the ring is detached from the child, as detected by a sudden drop of weight of the ring, detected by the weight detector; and if the child is currently unsafe, directing the ring to a safe location, wherein the directing comprises: using the propeller included in the ring to steer the ring in a direction with a water depth that is lower than the certain limit; and using the rf transmitter to transmit rescue signals.

What is claimed is:

1. A swimming hoop ring for detecting safety of children, comprising:
a ring made of plastic, wherein the ring is being worn by a child;
a top GPS receiver on a top surface of the ring, wherein the top GPS receiver is used to detect location of the ring when the top surface of the ring surfaces onto water;
a bottom GPS receiver on a bottom surface of the ring, wherein the bottom GPS server can be used to detect location of the ring when the top GPS receiver fails to operate as the top surface of the ring is flipped upside down into the water;
a rf transmitter included in the ring, wherein the rf transmitter can be used to transmit rescue signals;
a propeller included in the ring to steer the ring in certain directions;
a weight detector included in the ring to detect if there is a sudden drop of weight of the ring to indicate the child is being unsafe;
a processor;
a memory storing instructions that can execute the processor to execute a method

2. The swimming hoop ring of claim 1, wherein the method comprises:
detecting whether the child is currently safe, wherein the detection includes:
using the top GPS receiver or the bottom GPS receiver to detect the current location of the ring; and
if water depth of the current location exceed a certain limit, indicating that the child is currently unsafe; and
if the child is currently unsafe, directing the ring to a safe location, wherein the directing comprises:
using the propeller included in the ring to steer the ring in a direction with a water depth that is lower than the certain limit.

3. The swimming hoop ring of claim 1, wherein the method comprises:
detecting whether the child is currently safe, wherein the detection includes:
using the top GPS receiver or the bottom GPS receiver to detect the current location of the ring;
if water depth of the current location exceed a certain limit, indicating that the child is currently unsafe; and
if the current location belongs to an active area with dangerous water animals, indicating that this the child is currently unsafe; and
if the child is currently unsafe, directing the ring to a safe location, wherein the directing comprises:
using the propeller included in the ring to steer the ring in a direction with a water depth that is lower than the certain limit; and
using the rf transmitter to transmit rescue signals.

4. The swimming hoop ring of claim 1, wherein the method comprises:
detecting whether the child is currently safe, wherein the detection includes:
using the top GPS receiver or the bottom GPS receiver to detect the current location of the ring;
if water depth of the current location exceed a certain limit, indicating that the child is currently unsafe;
if the current location belongs to an active area with dangerous water animals, indicating that this the child is currently unsafe;
if the ring is detached from the child, as detected by a sudden drop of weight of the ring, detected by the weight detector; and
if the child is currently unsafe, directing the ring to a safe location, wherein the directing comprises:
using the propeller included in the ring to steer the ring in a direction with a water depth that is lower than the certain limit; and
using the rf transmitter to transmit rescue signals.
